(19) United States
(12) Patent Application Publication
(10) Pub. No.: US 2020/0259960 A1
(43) Pub. Date: Aug. 13, 2020

(54) PROVIDING GUARANTEED QUALITY OF SERVICE FOR INTERNET OF THINGS DEVICES IN CELLULAR NETWORK

(71) Applicant: Cisco Technology, Inc., San Jose, CA (US)

(72) Inventors: Gonzalo A. SALGUEIRO, Raleigh, NC (US); Santosh Ramrao PATIL, Santa Clara, CA (US); M. David HANES, Lewisville, NC (US); Akram I. SHERIFF, San Jose, CA (US)

(21) Appl. No.: 16/272,966

(22) Filed: Feb. 11, 2019

(51) Int. Cl. H04M 15/00; H04W 36/00; H04W 8/08; H04W 88/16; H04W 4/80

(52) U.S. Cl. CPC H04M 15/66; H04W 36/0022; H04W 4/80; H04W 88/16; H04W 8/08

(57) ABSTRACT

Techniques for establishing network policy parameters for an internet of things (IoT) device. A first network message is received from the IoT device using a cellular communication network. The first network message includes a protocol configuration options (PCO) element including a network policy identifier relating to the IoT device. A packet data network gateway (PGW) in the cellular communication network determines network policy parameters relating to the IoT device and the cellular communication network, based on the policy identifier. The network policy parameters for the IoT device are established in the cellular communication network.

Aspects of the present disclosure relate to cellular communications, and more specifically, though not exclusively, to techniques for establishing policy parameters for internet of things devices in cellular networks.

### BACKGROUND

The internet of things (IoT) can be described as adding networking capabilities to physical objects or “things” that serve some purpose or function outside of computing and/or networking technologies (i.e., traditionally “unconnected” or “offline” devices). In general, these “things,” sometimes referred to as IoT enabled-devices or IoT devices, are embedded with electronics, software, and network interfaces, which enable the physical objects to send and/or receive data packets over a network.

IoT devices connected via cellular services are playing a mission-critical role across many industries, such as manufacturing and industrial, transportation, the health care industry, etc. Within all of these industries, there is a need to transport meta data and other types of information for the IoT devices. For example, assuring and providing guaranteed quality of service (QoS) for data transferred between IoT devices and IoT servers is becoming more and more important.

Currently, there is no good solution available for an IoT device on a cellular network to inform the network of meta-data based requirements (e.g., security, QoS, or other requirements) or negotiate with the network infrastructure for these requirements. For example, an IoT device on a cellular network may be unable to communicate the type of data, data rate, latency, and other QoS parameters or transport services it will need. This lack of a solution can require the network infrastructure to either manually take input from a network administrator or use best effort service for IoT devices.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a system for establishing policies for internet of things (IoT) devices using a cellular network, according to one embodiment described herein.

FIG. 2 further illustrates a system for establishing policies for IoT devices using a cellular network, according to one embodiment described herein.

FIG. 3 illustrates a packet data network gateway (PGW) and policy charging and rules function (PCRF) server, according to one embodiment described herein.

FIG. 4 illustrates a protocol configuration options (PCO) element in a cellular network, according to one embodiment described herein.

FIG. 5 illustrates using a manufacturer usage description (MUD) profile with IoT devices using a cellular network, according to one embodiment described herein.

FIG. 6 is a flowchart illustrating establishing policies for IoT devices using a cellular network, according to one embodiment described herein.

FIG. 7 illustrates establishing policies for IoT devices using a cellular network, according to one embodiment described herein.

FIG. 8 further illustrates establishing policies for IoT devices using a cellular network, according to one embodiment described herein.

FIG. 9 is a flowchart illustrating establishing policies for IoT devices using a cellular network, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DESCRIPTION OF EXAMPLE EMBODIMENTS

### Overview

One embodiment provides a method of establishing network policy parameters for an internet of things (IoT) device. The method includes receiving a first network message from the IoT device using a cellular communication network. The first network message includes a protocol configuration options (PCO) element including a network policy identifier relating to the IoT device. The method further includes determining, using a packet data network gateway (PGW) in the cellular communication network and based on the policy identifier, one or more network policy parameters relating to the IoT device and the cellular communication network. The method further includes establishing the one or more network policy parameters for the IoT device in the cellular communication network.

Another embodiment provides a computer program product for establishing network policy parameters for an IoT device. The computer program product includes a computer-readable storage medium having computer-readable program code embodied therewith. The computer-readable program code is executable by one or more computer processors to perform an operation. The operation includes receiving a first network message from the IoT device using a cellular communication network. The first network message includes a PCO element including a network policy identifier relating to the IoT device. The operation further includes determining, using a PGW in the cellular communication network and based on the policy identifier, one or more network policy parameters relating to the IoT device and the cellular communication network. The operation further includes establishing the one or more network policy parameters for the IoT device in the cellular communication network.

Another embodiment provides a system, including a processor and a memory storing a program, which, when executed on the processor, performs an operation. The operation includes receiving a first network message from the IoT device using a cellular communication network. The first network message includes a PCO element including a network policy identifier relating to the IoT device. The operation further includes determining, using a PGW in the cellular communication network and based on the policy identifier, one or more network policy parameters relating to the IoT device and the cellular communication network. The operation further includes establishing the one or more network policy parameters for the IoT device in the cellular communication network.

### EXAMPLE EMBODIMENTS

Different IoT devices connected to a cellular network may wish to inform the cellular network infrastructure of network policy requirements (e.g., security, QoS, or other requirements). As one example, different IoT devices may require a different network QoS. For example, a critical device in an industrial or healthcare application may require a higher QoS than a passive meter. Similarly, a device streaming real-time data, like a security camera, may require a higher QoS than a device providing intermittent and less time-sensitive data. QoS can refer to a number of different parameters relating to the network, including jitter, packet loss, latency, etc. Further, QoS can refer to additional parameters, including peak bandwidth, a number of packets per minute, etc.

One or more techniques disclosed herein facilitate informing a network infrastructure of policy and dynamic bandwidth requirements of a user equipment (UE) using the protocol configuration option (PCO) parameter of network messages. For example, policy (including dynamic bandwidth) information can be provided to a packet data network gateway (PGW) using the PCO parameter of a non-access stratum (NAS) network message. The PGW can then communicate with a policy charging and rules function (PCRF) to apply the policies for the IoT device. This can be done for QoS policies, firewall and security policies, device capability policies, or any other suitable policy.

In one embodiment the manufacturer usage description (MUD) architecture can be used to provide policies for IoT devices connected to a cellular network. MUD has been developed to provide improved security of IoT devices. MUD is described in a proposed Internet Engineering Task Force (IETF) specification. MUD can provide a way for IoT devices to provide security configuration and access policies to a network. For example, an IoT device can use MUD to provide policy information to a network about which devices the IoT device should be allowed to access, what transmission protocols should be allowed, what controller(s) or domain name servers (DNS) are allowed to be used, etc. In the MUD architecture, a MUD uniform resource identifier (URI) is provided by the IoT device to the network. The network uses the MUD URI to retrieve a MUD file from a MUD file server (e.g., a MUD file server maintained by a manufacturer, retailer, systems integrator, etc. of the IoT device). The network then applies the policies for the IoT device described in the MUD file.

In an enterprise or home wireless network, an IoT device can broadcast the MUD URI to the wireless network using an access switch or a similar interface. But this is not effective for IoT devices connected to a cellular network. In an embodiment, a MUD URI can be provided from the IoT device to the cellular PGW using a PCO parameter. An element in the cellular network (e.g., the PGW or a PCRF) can then retrieve a MUD file for the IoT device using the MUD URI, and can apply the policies described in the MUD file to the network for the IoT device.

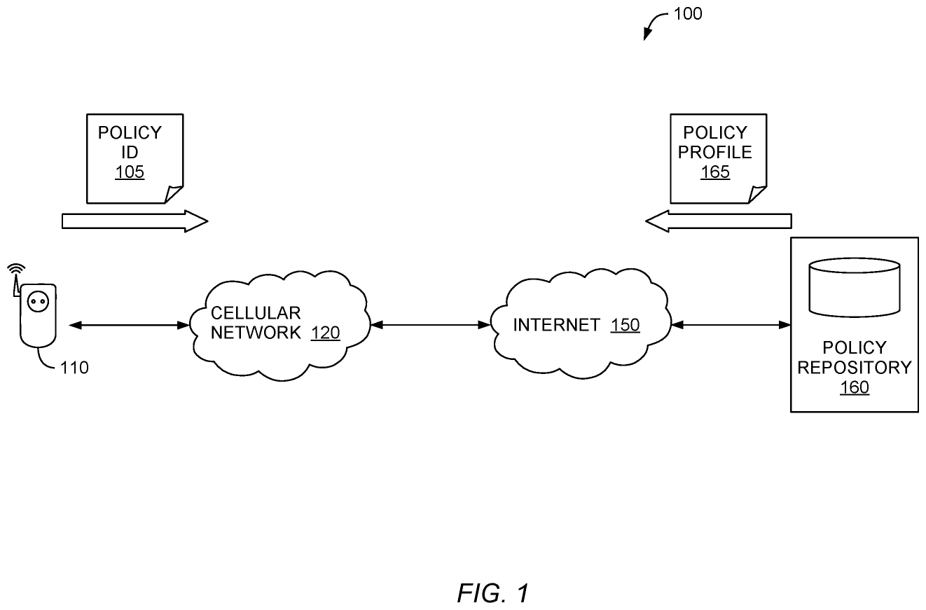

FIG. 1 illustrates a system for establishing policies for IoT devices using a cellular network, according to one embodiment described herein. A system 100 includes an IoT device 110. The IoT device 110 is connected to a cellular network 120. The IoT device 110 transmits a policy ID 105 to the cellular network. In an embodiment, this policy ID 105 is used by the cellular network 120 to identify a network policy profile 165 relating to the IoT device 110. The cellular network 120 transmits the policy ID 105 over the internet 150 to a policy repository 160. The policy repository 160 provides the policy profile 165 corresponding to the policy ID 105.

For example, the system 100 could be used to establish a QoS policy for the IoT device 110. In this embodiment, the policy ID 105 is a MUD URI, the policy repository 160 is a MUD file server and the policy profile 165 is a MUD file. In an embodiment, the cellular network 120 uses the MUD file (e.g., the policy profile 165) to identify the desired QoS for the IoT device, and establishes that QoS for the IoT device. As described in the MUD specification, a MUD file can provide security profile information. For example, a MUD file could specify:

Allow access to host controller.example.com with QoS AF11
Allow access to devices of the same manufacturer
Allow access to and from controllers who need to speak COAP
Allow access to local DNS/DHCP
Deny all other access

As described in application Ser. No. 16/172,766, herein incorporated by reference, the MUD file could be enhanced to include additional information relating to QoS and type of device. For example, the MUD file could be expanded to include device capability for uplink and downlink traffic and QoS expected. The QoS expected could include application criticality/priority (e.g., from 1 to 5), guaranteed bit rate expectation (e.g., uplink and downlink in mbps), latency range/packet delay budget (e.g., in ms), and packet error loss rate.

Alternatively, the policy profile 165 could be a security policy (e.g., a firewall policy), a device capability policy, or any other suitable policy that is not related to the MUD architecture. Further, in an alternative embodiment, the policy ID 105 itself could be used by the cellular network to establish the desired policy. For example, the policy ID 105 could include desired parameters relating to a security policy, or another suitable policy. Rather than using the policy ID 105 to retrieve the policy profile 165 from the policy repository 160, the cellular network 120 could parse the policy ID 105 directly and establish the desired policy.

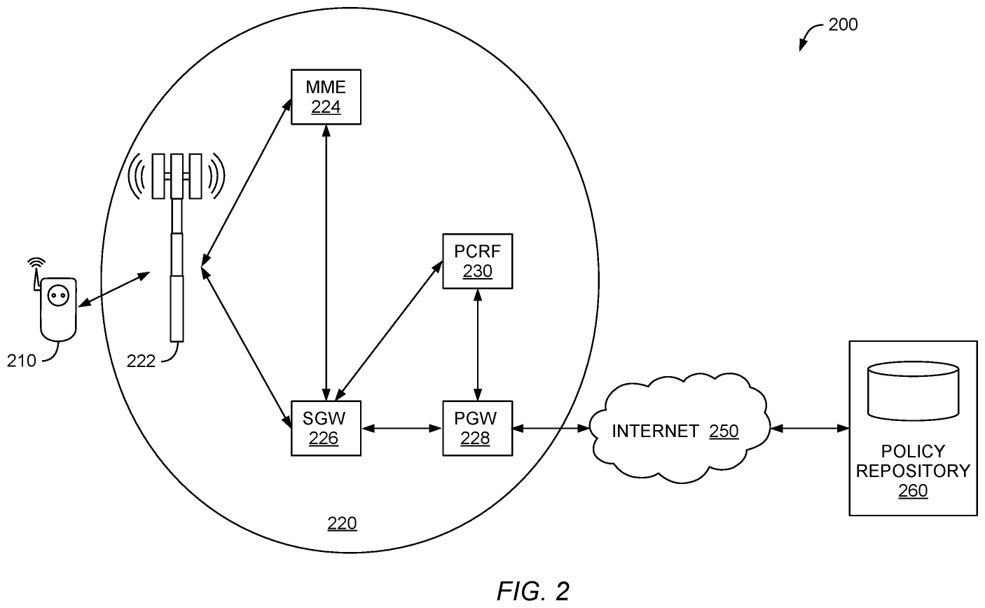

FIG. 2 further illustrates a system for establishing policies for IoT devices using a cellular network, according to one embodiment described herein. In an embodiment, FIG. 2 illustrates a system 200 which corresponds with the system 100 illustrated in FIG. 1, but with additional detail relating to a cellular network 220.

The cellular communication network 220 (e.g., an LTE communication network) includes base station 222 (e.g., an evolved node B (eNodeB)), a PDN gateway (PGW) 228, a serving gateway (SGW) 226, and a mobility management entity (MME) 224. The evolved packet core (EPC) of an LTE communication network includes the MME 224, SGW 226 and PGW 228 components. In one embodiment, each of the EPC components (e.g., the MME 224, SGW 226, and PGW 228) is implemented in a different gateway or network device. Alternatively, one or more EPC components can be implemented on the same gateway or network device.

The SGW 226 resides in the user plane where it forwards and routes packets to and from the base station 222 and PGW 228. The SGW 226 also serves as the local mobility anchor for inter-eNodeB handover and mobility between 3GPP networks. The SGW 226 routes and forwards user data packets, while also acting as the mobility anchor for the user plane during inter-eNB handovers and as the anchor for mobility between LTE and other 3GPP technologies (terminating S4 interface and relaying the traffic between 2G/3G systems and PGW). For idle state user equipment, the SGW 226 terminates the down link data path and triggers paging when down link data arrives for the user equipment. The SGW 226 manages and stores user equipment contexts, e.g. parameters of the IP bearer service and network internal routing information. The SGW 226 also performs replication of the user traffic in case of lawful interception.

The PGW 228 acts as the interface between the cellular network 220 and other packet data networks, such as the Internet 250. The PGW 228 serves as the anchor point for intra-3GPP network mobility, as well as mobility between 3GPP and non-3GPP networks. The PGW 228 provides connectivity to the UE (e.g., the IoT device 210) to external packet data networks by being the point of exit and entry of traffic for the UE. A UE may have simultaneous connectivity with more than one PGW for accessing multiple packet data networks. The PGW 228 performs policy enforcement, packet filtering for each user, charging support, lawful interception, and packet screening. The PGW 228 also provides an anchor for mobility between 3GPP and non-3GPP technologies such as WiMAX and 3GPP2 standards.

Policy and charging rules function (PCRF) 230 can determine the policy rules associated with subscribers in a communication network. The PCRF 230 can access subscriber databases and charging systems in a scalable manner. The PCRF 230 can communicate with the network operator's IP service domain over an Rx+ interface. The PCRF 230 can also communicate with a PGW 228 over an S7 interface. In some embodiments, the PCRF 230 can also communicate with an MME 224.

The MME 224 resides in the EPC control plane and manages session states, authentication, paging, mobility with 3GPP 2G/3G nodes, roaming, and other bearer management functions. The MME 224 can be a standalone element or integrated with other EPC elements, including the SGW 226 and PGW 228. The MME 224 can also be integrated with 2G/3G elements.

The MME 224 is a control-node for the LTE access network. The MME 224 is responsible for UE tracking and paging procedures including retransmissions. MME 224 handles the bearer activation/deactivation process and is also responsible for choosing the SGW 226 for a UE at the initial attach and at time of an intra-LTE handover. The MME 224 can communicate with the SGW 226 over a S11 interface. In some embodiments, the MME 224 can communicate with a PGW 228 over a directly connected interface, including an Sxx signaling interface. In other embodiments, the MME 224 can communicate with a PGW 228 via a SGW 226 over proxied interfaces, S5 and S11. In some embodiments, the MME 224 can communicate with operator's IP services over an Sxx interface.

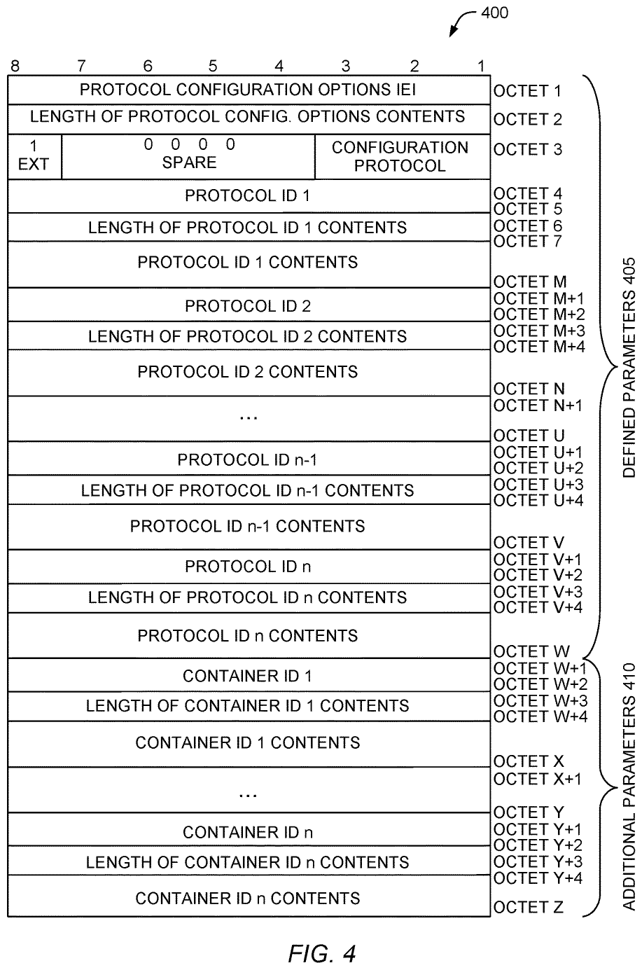

An IoT device 210 establishes a cellular connection with the base station 222 (e.g., an eNodeB). As discussed in more detail with regard to FIGS. 4-8, in an embodiment the IoT device 210 provides a policy ID to the base station 222 using a PCO parameter. The base station 222 communicates the PCO parameter to the PGW 228, which communicates with the PCRF 230 and uses the policy ID in the PCO parameter to retrieve a policy profile from the policy repository 260.

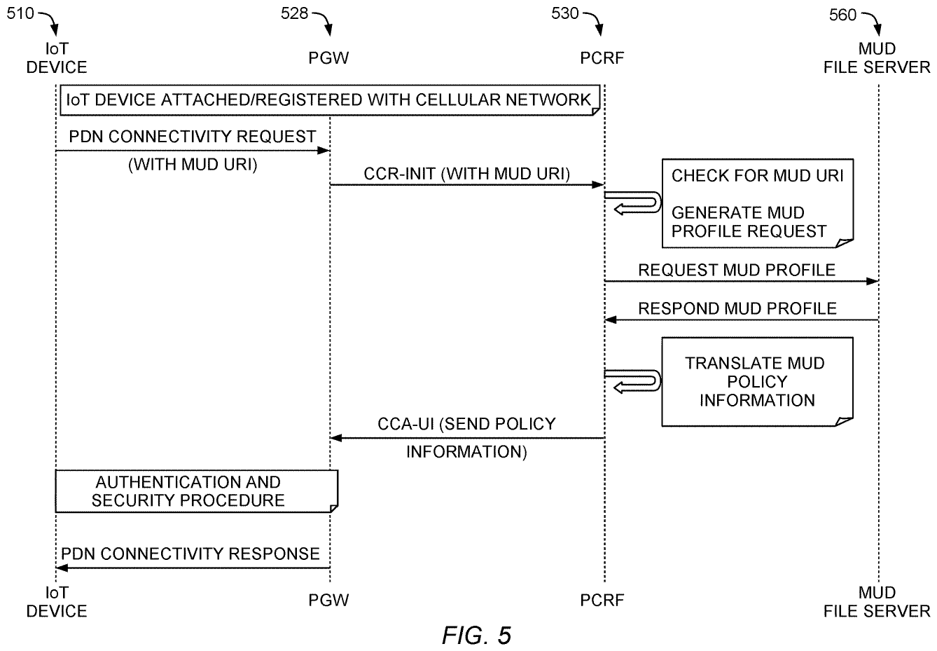

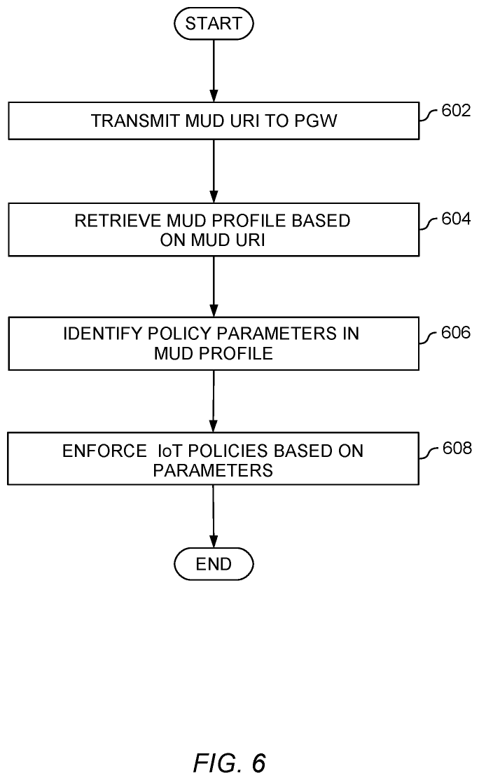

For example, the system 200 could be used to establish a QoS policy for the IoT device 210. In this embodiment, the policy ID is a MUD URI, the policy repository 260 is a MUD file server and the policy profile is a MUD file. In an embodiment, as illustrated further with regard to FIGS. 5 and 6, below, the PGW 228 and PCRF 230 use the MUD file to identify the desired QoS for the IoT device, and establish that QoS for the IoT device. Alternatively, the policy could be a security policy (e.g., a firewall policy), a device capability policy, or any other suitable policy.

Further, in an alternative embodiment, the policy ID itself could be used by the PCRF 230 and PGW 228 to establish the desired policy. For example, the policy ID could include desired parameters relating to a security policy, or another suitable policy. Rather than using the policy ID to retrieve the policy profile from the policy repository 260, the PCRF 230 or PGW 228 could parse the policy ID directly and establish the desired policy.

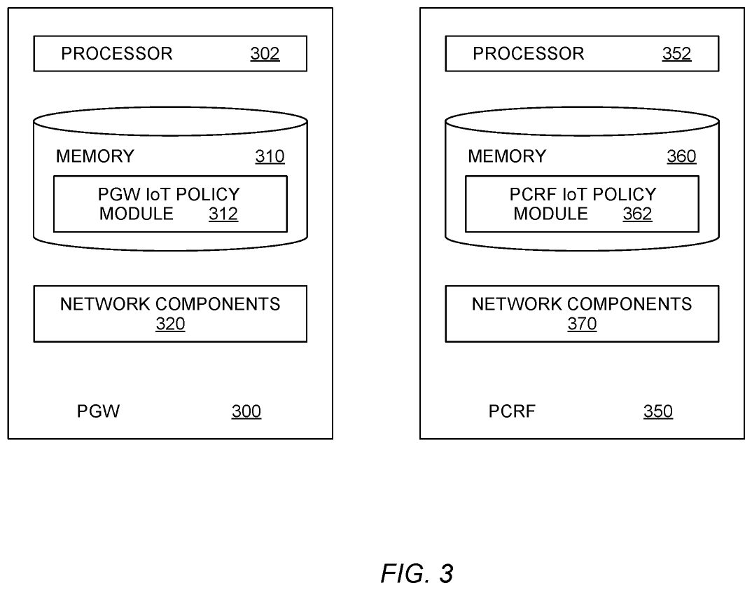

FIG. 3 illustrates a PGW 300 and PCRF 350, according to one embodiment described herein. The PGW 300 includes a processor 302, a memory 310, and network components 320. The processor 302 generally retrieves and executes programming instructions stored in the memory 310. The processor 302 is included to be representative of a single central processing unit (CPU), multiple CPUs, a single CPU having multiple processing cores, graphics processing units (GPUs) having multiple execution paths, and the like. In one embodiment, the PGW 300 and PCRF 350 are implemented in separate servers. Alternatively, the PGW 300 and PCRF 350 are implemented in the same server.

The network components 320 include the components necessary for the PGW 300 to interface with a cellular communication network. For example, the network components 320 can includes cellular network interface components and associated software. Although the memory 310 is shown as a single entity, the memory 310 may include one or more memory devices having blocks of memory associated with physical addresses, such as random access memory (RAM), read only memory (ROM), flash memory or other types of volatile and/or non-volatile memory. The memory 310 generally includes program code for performing various functions related to use of the PGW 300. The program code is generally described as various functional “applications” or “modules” within the memory 310, although alternate implementations may have different functions and/or combinations of functions. Within the memory 310, the IoT PGW IoT policy module 312 establishes policies for IoT devices, as described in relation to FIGS. 4-8.

The PCRF 350 includes a processor 352, a memory 360, and network components 370. The processor 352 generally retrieves and executes programming instructions stored in the memory 360. The processor 352 is included to be representative of a single central processing unit (CPU), multiple CPUs, a single CPU having multiple processing cores, graphics processing units (GPUs) having multiple execution paths, and the like.

The network components 370 include the components necessary for the PCRF 350 to interface with a cellular communication network. For example, the network components 370 can includes cellular network interface components and associated software. Although the memory 360 is shown as a single entity, the memory 360 may include one or more memory devices having blocks of memory associated with physical addresses, such as random access memory (RAM), read only memory (ROM), flash memory or other types of volatile and/or non-volatile memory. The memory 360 generally includes program code for performing various functions related to use of the PCRF 350. The program code is generally described as various functional “applications” or “modules” within the memory 360, although alternate implementations may have different functions and/or combinations of functions. Within the memory 360, the PCRF IoT policy module 362 establishes policy for IoT devices, as described in relation to FIGS. 4-8.

FIG. 4 illustrates a PCO information element 400 in a cellular network, according to one embodiment described herein. The PCO 400 is used in LTE as a means by which a device can indirectly exchange information with the PGW. The information is typically related to a particular packet data network (PDN) connection. For example, PCO information could include the address of a domain name system (DNS) server. In an embodiment, the PCO 400 can be enhanced to include a field for IoT device policy to share with the PGW.

The PCO 400 is a component of a NAS message. The PCO 400 can be carried by numerous different messages in a cellular communication network, including a PDN connectivity request and an ActivateDefaultEPSBearerContextRequest. Details about the PCO 400 are described in 3GPP TS 24.008. For example, Section 10.5.6.3 of TS 24.008 includes additional description related to the PCO.

As illustrated in FIG. 4, octets “1” through “w” in the PCO 400 are defined parameters 405. The defined parameters 405 illustrate parameters already defined for use in existing cellular (e.g., LTE) implementations. Octets “w+1” through “z” represent additional parameters 410. The additional parameters 410 represent additional parameters that could be used in particular cellular network implementations. The additional parameters 410 can be included when special parameters or requests are to be transferred to the network. These parameters or requests may not be related to a specific configuration protocol, and therefore are not encoded as packets contained in the PCO list.

For example, particular additional parameters 410 can be included in the PCO 400 by including a container ID (e.g., 2 octets), a length of the contents of the container (e.g., 1 octet), and the contents of the container (e.g., n octets). In an embodiment, an IoT policy ID (e.g., the IoT policy ID 105 illustrated in FIG. 1) can be included in the additional parameters 410 of the PCO. For example, the table below illustrates container IDs for use in the mobile station (MS) to network direction:

Container IDs

MS to network direction:
0001H (P-CSCF IPv6 Address Request);
0002H (IM CN Subsystem Signaling Flag);
0003H (DNS Server IPv6 Address Request);
0004H (Not Supported);
0005H (MS Support of Network Requested Bearer Control indicator);
0006H (Reserved);
0007H (DSMIPv6 Home Agent Address Request);
0008H (DSMIPv6 Home Network Prefix Request);
0009H (DSMIPv6 IPv4 Home Agent Address Request);
000AH (IP address allocation via NAS signaling);
000BH (IPv4 address allocation via DHCPv4);
000CH (P-CSCF IPv4 Address Request);
000DH (DNS Server IPv4 Address Request);
000EH (MSISDN Request);- 000FH (IFOM-Support-Request);
0010H (IPv4 Link MTU Request); and
0011H (loT Policy ID)
FF00H to FFFFH reserved for operator specific use

In an embodiment, as illustrated, the container ID 0011H can be used to identify the IoT policy ID. This is merely an example, and another suitable container ID could be used instead

FIG. 5 illustrates using a MUD profile with IoT devices using a cellular network, according to one embodiment described herein. As discussed above, a MUD profile (e.g., a MUD file) is one example of an IoT policy (e.g., the policy profile 165 illustrated in FIG. 1) suitable for use with one or more embodiments described herein. An IoT device 510 is attached to and registered with a cellular network including a PGW 528 and a PCRF 530. The IoT device 510 sends a PDN connectivity request to the PGW 528. In an embodiment, this is a standard PDN connectivity request (e.g., in an LTE cellular network), except the PCO includes a MUD URI as an IoT policy ID. This is described in more detail with regard to FIG. 4, above.

The PGW 528 receives the PDN connectivity request with the MUD URI. In one embodiment, the PGW 528 can ask the PCRF 530 to interface with the MUD file server 560 and retrieve the MUD profile specified by the MUD URI. The PGW 528 transmits a CCR-Init message to the PCRF 530. The CCR-Init message includes the MUD URI received from the IoT device 510. The PCRF 530 receives the CCR-Init message, and checks the message for a MUD URI. The PCRF 530 identifies the MUD URI, and generates a MUD profile request using the MUD URI (e.g., the MUD URI defines the destination address for the relevant MUD profile). The PCRF 530 transmits a request for the MUD Profile to a MUD file server 560. In an embodiment, the MUD file server 560 stores a MUD profile associated with the IoT device and defining the QoS, security policies, or other policies for the IoT device.

The MUD file server 560 receives the MUD profile request and transmits the MUD profile to the PCRF 530 in response. The PCRF 530 receives the MUD profile, and translates the MUD profile to identify the MUD policy information (e.g., QoS information for the IoT device). The PCRF 530 transmits a CCA-UI message to the PGW 528 including the translated policy information. For example, the CCA-UI message can include QoS/QCI information, firewall information other policy information.

Alternatively, the PGW 528 can directly reach the MUD file server 560 to retrieve the MUD profile. That is, instead of going through the PCRF 530, the PGW 528 can directly retrieve the MUD profile from the MUD file server 560. The PGW 528 can then either provide the MUD profile to the PCRF to translate and apply the policies specified in the MUD profile, or the PGW 528 can itself translate and apply the policies specified in the MUD profile.

The PGW 528 further undertakes authentication and security procedures with the IoT device 510. As part of those procedures the PGW 528 transmits to the IoT device 510 a PDN connectivity response. As part of the PDN connectivity response, the PGW 528 can provide the allowed QoS, QoS class identifier (QCI), or other parameters. For IoT devices, the PGW 528 can use the MUD profile information to map the QoS/QCI to be allowed for the IoT device 510 device based on a specified data rate and quality of service expectation in MUD profile. Alternatively, or in addition, the PGW 528 can use the MUD profile to identify information about which destination IPs, ports, and protocols should be allowed or used by the IoT device 510, or any other suitable policy information. The PGW 528 can use this information to make those policies part of the PDN connectivity response and can update the PCRF 530 with those policies.

As illustrated in FIG. 5, in one embodiment the PGW 528 uses the MUD URI received from the IoT device 510 to retrieve a MUD file including policy information. Alternatively, or in addition, the desired policy information could be provided directly from the IoT device 510 to the PGW 528. For example, the PGW 528 or PCRF 530 could use the MUD URI to identify desired QoS or other policy information, without retrieving a MUD file. As another example, the IoT device 510 could provide a different identifier and the PGW 528, or PCRF 530, could use the identifier to determine policy information for the IoT device.

FIG. 6 is a flowchart illustrating establishing policies for IoT devices using a cellular network, according to one embodiment described herein. At block 602, an IoT device (e.g., the IoT device 510 illustrated in FIG. 5) transmits a MUD URI, or another suitable identifier, to a PGW (e.g., the PGW 528 illustrated in FIG. 5). As discussed above in relation to FIGS. 4-5, the MUD URI could be included as a PCO parameter in a PDN connectivity request. At block 604, the PGW (e.g., the PGW IoT policy module 312 illustrated in FIG. 3) retrieves a MUD profile related to the IoT device using the MUD URI. As discussed above in relation to FIG. 5, in an embodiment the PGW asks a PCRF (e.g., the PCRF 530 illustrated in FIG. 5) to retrieve the MUD profile using the MUD URI (e.g., using the PCRF IoT policy module 362 illustrated in FIG. 3). Alternatively, the PGW retrieves the MUD profile directly.

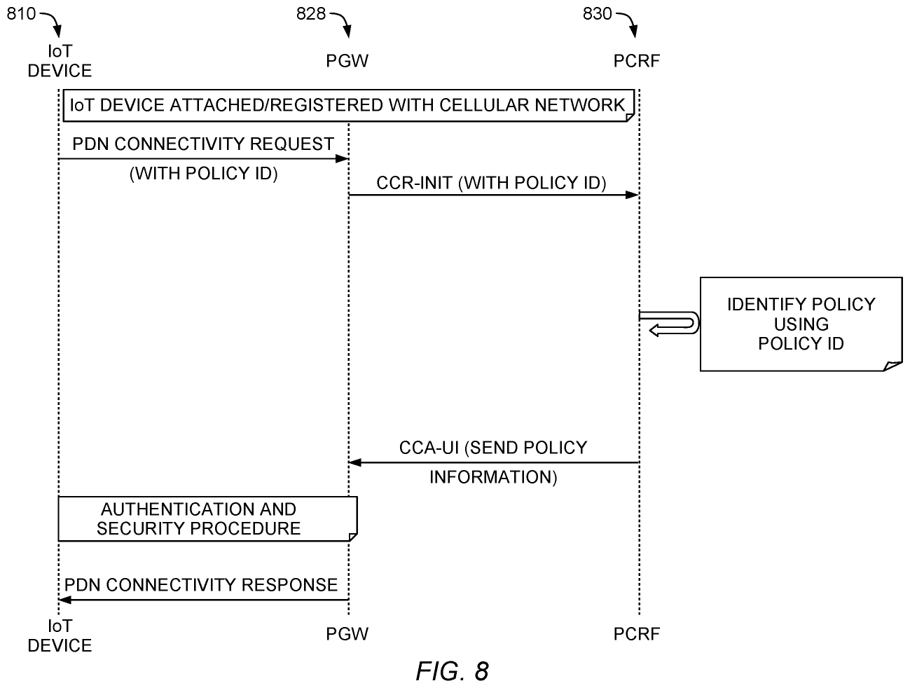

At block 606, the PCRF identifies policy parameters in the MUD profile (e.g., using the PCRF IoT policy module). For example, the MUD profile can specific QoS information, security information, or other policy information for the IoT device. The PCRF can parse the MUD profile and identify the policy information. Alternatively, as discussed above in relation to FIG. 5, the PGW can identify policy parameters in the MUD profile. Further, as discussed above and as discussed further below in relation to FIG. 8, in an embodiment the PGW or PCRF can identify policy parameters directly from the MUD URI, or other identifier, without retrieving a MUD profile.

At block 608, the PGW enforces the IoT policies based on the parameters. In an embodiment, as discussed above in relation to FIG. 5, the PGW can transmit a PDN connectivity response with the identified policy parameters (e.g., QoS/QCI information, firewall information, or other policy parameters). Further, the PCRF can use the parameters to enforce the policies for the IoT device. In an embodiment, the PCRF identifies the policy parameters and enforces them. Alternatively, the PGW identifies the policy parameters and provides them to the PCRF.

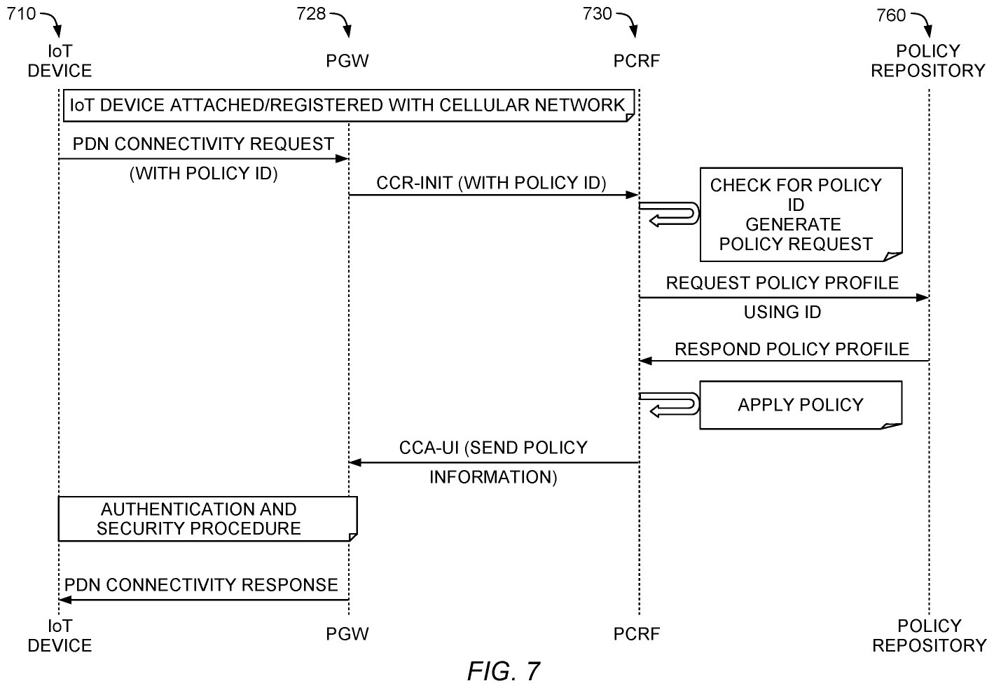

FIG. 7 illustrates establishing policies for IoT devices using a cellular network, according to one embodiment described herein. As discussed above in relation to FIG. 2, in one embodiment a MUD URI is used to identify policy parameters for an IoT device. Alternatively, a different policy ID could be used.

An IoT device 710 is attached to and registered with a cellular network including a PGW 728 and a PCRF 730. The IoT device 710 sends a PDN connectivity request to the PGW 728. In an embodiment, this is a standard PDN connectivity request (e.g., in an LTE cellular network), except the PCO includes an IoT policy ID. This is described in more detail with regard to FIG. 4, above.

The PGW 728 receives the PDN connectivity request with the policy ID. In one embodiment, the PGW 728 can ask the PCRF 730 to interface with the policy repository 760 and retrieve the policy profile specified by the policy ID. The PGW 728 transmits a CCR-Init message to the PCRF 730. The CCR-Init message includes the policy ID received from the IoT device 710. The PCRF 730 receives the CCR-Init message, and checks the message for a policy ID. The PCRF 730 identifies the policy ID, and generates a policy request using the policy ID (e.g., the policy ID identifies the relevant policy profile at the policy repository 760). The PCRF 730 transmits a request for the policy profile to the policy repository 760. In an embodiment, the policy repository 760 stores a policy profile associated with the IoT device and defining the QoS, security policies, or other policies for the IoT device.

The policy repository 760 receives the policy request and transmits the policy profile to the PCRF 730 in response. The PCRF 730 receives the policy profile, and translates the policy profile to identify the policy information (e.g., QoS information for the IoT device). The PCRF 730 transmits a CCA-UI message to the PGW 728 including the translated policy information. For example, the CCA-UI message can include QoS/QCI information, firewall information other policy information.

Alternatively, the PGW 728 can directly reach the policy repository 760 to retrieve the policy profile. That is, instead of going through the PCRF 730, the PGW 728 can directly retrieve the policy profile from the policy repository 760. The PGW 728 can then either provide the policy profile to the PCRF 730 to translate and apply the policies specified in the policy profile, or the PGW 728 can itself translate and apply the policies specified in the policy profile.

The PGW 728 further undertakes authentication and security procedures with the IoT device 710. As part of those procedures the PGW 728 transmits to the IoT device 710 a PDN connectivity response. As part of the PDN connectivity response, the PGW 728 can provide the allowed QoS, QCI, or other parameters. For IoT devices, the PGW 728 can use the policy information to map the QoS/QCI to be allowed for the IoT device 710 device based on a specified data rate and quality of service expectation in policy. Alternatively, or in addition, the PGW 728 can use the policy to identify information about which destination IPs, ports, and protocols should be allowed or used by the IoT device 710, or any other suitable policy information. The PGW 728 can use this information to make those policies part of the PDN connectivity response and can update the PCRF 730 with those policies.

FIG. 8 further illustrates establishing policies for IoT devices using a cellular network, according to one embodiment described herein. As illustrated in FIG. 7, in one embodiment the PGW 728 uses the policy ID received from the IoT device 710 to retrieve a policy. Alternatively, or in addition, the desired policy information could be provided directly from the IoT device 710 to the PGW 728. This is illustrated in FIG. 8.

An IoT device 810 is attached to and registered with a cellular network including a PGW 828 and a PCRF 830. The IoT device 810 sends a PDN connectivity request to the PGW 828. In an embodiment, this is a standard PDN connectivity request (e.g., in an LTE cellular network), except the PCO includes an IoT policy ID. This is described in more detail with regard to FIG. 4, above.

The PGW 828 receives the PDN connectivity request with the policy ID. In one embodiment, the PGW 828 can use the PCRF 830 to identify policy information based on the policy ID. The PGW 828 transmits a CCR-Init message to the PCRF 830. The CCR-Init message includes the policy ID received from the IoT device 810. The PCRF 830 receives the CCR-Init message, and checks the message for a policy ID. The PCRF 830 identifies the policy ID, and uses the policy ID to identify the desired policy parameters. For example, the policy ID could include encoded parameters, which the PCRF could use to identify the desired policy (e.g., QoS/QCI parameters, security parameters, or other parameters). As another example, the PCRF 830 could maintain a local lookup table or database of policy information, and could retrieve the policy information using the policy ID.

The PCRF 830 transmits a CCA-UI message to the PGW 828 including the translated policy information. For example, the CCA-UI message can include QoS/QCI information, firewall information other policy information. Alternatively, the PGW 828 itself identifies policy information using the policy ID, without relying on providing the policy ID to the PCRF.

The PGW 828 further undertakes authentication and security procedures with the IoT device 810. As part of those procedures the PGW 828 transmits to the IoT device 810 a PDN connectivity response. As part of the PDN connectivity response, the PGW 828 can provide the allowed QoS, QCI, or other parameters. For IoT devices, the PGW 828 can use the policy information to map the QoS/QCI to be allowed for the IoT device 810 device based on a specified data rate and quality of service expectation in policy. Alternatively, or in addition, the PGW 828 can use the policy to identify information about which destination IPs, ports, and protocols should be allowed or used by the IoT device 810, or any other suitable policy information. The PGW 828 can use this information to make those policies part of the PDN connectivity response and can update the PCRF 830 with those policies.

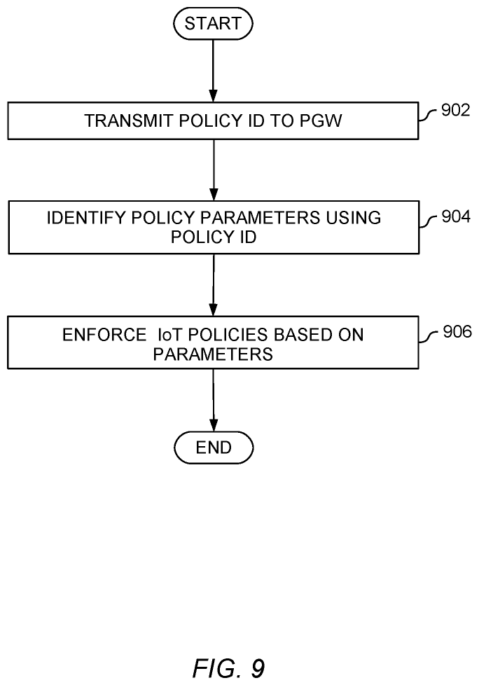

FIG. 9 is a flowchart illustrating establishing policies for IoT devices using a cellular network, according to one embodiment described herein. At block 902, an IoT device (e.g., the IoT device 710 illustrated in FIG. 7 or 810 illustrated in FIG. 8) transmits a policy ID, to a PGW (e.g., the PGW 728 illustrated in FIG. 7 or 828 illustrated in FIG. 8). As discussed above in relation to FIGS. 4-5, the policy ID could be included as a PCO parameter in a PDN connectivity request. At block 904, the PGW (e.g., the PGW IoT policy module 312 illustrated in FIG. 3) identifies policy parameters using the policy ID. As discussed above in relation to FIGS. 7 and 8, in an embodiment the PGW asks a PCRF (e.g., the PCRF 730 illustrated in FIG. 7 or 830 illustrated in FIG. 8) to identify the policy parameters using the policy ID (e.g., using the PCRF IoT policy module 362 illustrated in FIG. 3). Alternatively, the PGW identifies the policy parameters directly.

At block 906, the PGW enforces the IoT policies based on the parameters. In an embodiment, as discussed above in relation to FIGS. 7 and 8, the PGW can transmit a PDN connectivity response with the identified policy parameters (e.g., QoS/QCI information, firewall information, or other policy parameters). Further, the PCRF can use the parameters to enforce the policies for the IoT device. In an embodiment, the PCRF identifies the policy parameters and enforces them. Alternatively, the PGW identifies the policy parameters and provides them to the PCRF.

In an embodiment, the techniques illustrated in FIGS. 1-9 can be used to notify the cellular network that an IoT device is constrained and to identify the class of the device (e.g., as described in RFC 7228). This would let the network know what the IoT device's capabilities are from a power, CPU, and connection perspective. For example, in 5G networks devices are often expected to be able to seamlessly shift from cellular to Wi-Fi connections. If a device is constrained and does not have this capability, then this could be communicated in advance to the network as a policy parameter, so that these situations are avoided for the IoT device.

In another embodiment, the techniques illustrated in FIGS. 1-9 can be used to provide telemetry information (received signal strength indication, packet loss, etc.) to the cellular network. This telemetry could be provided directly in the PCO messaging or the protocol in which telemetry will be communicated can be defined by the IoT device.

If an IoT device (e.g., IoT device 210 illustrated in FIG. 2) has a dynamic bandwidth requirement due to Inter-MME handover or because of an increase in traffic, then an MME (e.g., MME 224 illustrated in FIG. 2) can trigger a change in QoS dynamically for the IoT device, or for a group of IoT devices. This can be done by communicating an additional PCO element to the PGW, which in turn can communicate with the PCRF. The PCRF can update the QoS/QCI information. Further, the PCRF can update the policy profile (e.g., the MUD file) stored at the policy repository (e.g., the MUD file server). The QoS information can thus be pushed to allocate the updated QoS for the IoT device.

In IoT cellular networks (e.g., LTE networks), processing NAS data protocol data units (PDUs) can cause a significant increase in LTE user equipment processing. This can stem from prioritization and congestion handling between the NAS signaling PDUs and NAS data PDUs at the MME. This congestion can be avoided on the MME by allocating preferred (or optimum) QoS metrics for the IoT devices. For example, after translating the QoS/QCI information from a policy profile (e.g., a MUD file), a PGW or PDN can directly provide an eNodeB the IoT device's QoS profile Information. This way any additional increase in processing load on the MME when IoT devices are present can be reduced, or avoided, by the MME. Further, the PGW can use the QoS profile information to make QoS policies part of a PDN connectivity response and can update the PCRF with the policies.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access data available in the cloud. For example, the policy repository 260 illustrated in FIG. 2 could be located at a storage location in the cloud. Doing so allows a user to access this information from any computing system attached to a network connected to the cloud (e.g., the Internet).

The flowchart and block diagrams in the Figures illustrate the architecture, functionality and operation of possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In view of the foregoing, the scope of the present disclosure is determined by the claims that follow.

1. A method of establishing network policy parameters for an internet of things (IoT) device, the method comprising:
receiving a first network message from the IoT device using a cellular communication network, wherein the first network message comprises a protocol configuration options (PCO) element comprising a network policy identifier relating to the IoT device;
determining, using a packet data network gateway (PGW) in the cellular communication network and based on the policy identifier, one or more network policy parameters relating to the IoT device and the cellular communication network; and
establishing the one or more network policy parameters for the IoT device in the cellular communication network, wherein establishing the one or more network policy parameters modifies a parameter of the cellular communication network.

2. The method of claim 1, further comprising:
retrieving a policy profile relating to the IoT device from a policy repository using the policy identifier; and
parsing the policy profile to identify the one or more network policy parameters.

3. The method of claim 2, wherein the network policy identifier comprises a manufacturer usage description (MUD) uniform resource identifier (URI), wherein the policy profile comprises a MUD profile, and wherein the policy repository comprises a MUD file server.

4. The method of claim 3, wherein the one or more network policy parameters comprise quality of service (QoS) parameters.

5. The method of claim 3, wherein the one or more network policy parameters comprise security parameters.

6. The method of claim 2, further comprising:
transmitting a second network message from the PGW to a policy and charging rules function (PCRF), the second network message comprising the policy identifier, wherein the PCRF retrieves the policy profile from the policy repository using the policy identifier.

7. The method of claim 2, wherein the PGW retrieves the policy profile from the policy repository using the policy identifier.

8. The method of claim 1, further comprising:
parsing the network policy identifier to determine the network policy parameters.

9. The method of claim 1, wherein the first network message comprises a packet data network (PDN) connectivity request.

10. The method of claim 1, wherein the PCO element comprises the network policy identifier in one or more octets between octet w+1 and octet z.

11. A computer program product for establishing network policy parameters for an internet of things (IoT) device, the computer program product comprising:
a non-transitory computer-readable storage medium having computer-readable program code embodied therewith, the computer-readable program code executable by one or more computer processors to perform an operation, the operation comprising:
receiving a first network message from the IoT device using a cellular communication network, wherein the first network message comprises a protocol configuration options (PCO) element comprising a network policy identifier relating to the IoT device;
determining, using a packet data network gateway (PGW) in the cellular communication network and based on the policy identifier, one or more network policy parameters relating to the IoT device and the cellular communication network; and
establishing the one or more network policy parameters for the IoT device in the cellular communication network, wherein establishing the one or more network policy parameters modifies a parameter of the cellular communication network.

12. The computer program product of claim 11, the operation further comprising:
retrieving a policy profile relating to the IoT device from a policy repository using the policy identifier; and
parsing the policy profile to identify the one or more network policy parameters.

13. The computer program product of claim 12, wherein the network policy identifier comprises a manufacturer usage description (MUD) uniform resource identifier (URI), wherein the policy profile comprises a MUD profile, and wherein the policy repository comprises a MUD file server.

14. The computer program product of claim 12, the operation further comprising:
transmitting a second network message from the PGW to a policy and charging rules function (PCRF), the second network message comprising the policy identifier, wherein the PCRF retrieves the policy profile from the policy repository using the policy identifier.

15. A system, comprising:
a processor; and
a memory storing a program, which, when executed on the processor, performs an operation, the operation comprising:
receiving a first network message from an internet of things (IoT) device using a cellular communication network, wherein the first network message comprises a protocol configuration options (PCO) element comprising a network policy identifier relating to the IoT device;
determining, using a packet data network gateway (PGW) in the cellular communication network and based on the policy identifier, one or more network policy parameters relating to the IoT device and the cellular communication network; and
establishing the one or more network policy parameters for the IoT device in the cellular communication network, wherein establishing the one or more network policy parameters modifies a parameter of the cellular communication network.

16. The system of claim 15, the operation further comprising:
retrieving a policy profile relating to the IoT device from a policy repository using the policy identifier; and
parsing the policy profile to identify the one or more network policy parameters.

17. The system of claim 16, wherein the network policy identifier comprises a manufacturer usage description (MUD) uniform resource identifier (URI), wherein the policy profile comprises a MUD profile, and wherein the policy repository comprises a MUD file server.

18. The system of claim 17, wherein the one or more network policy parameters comprise quality of service (QoS) parameters.

19. The system of claim 16, the operation further comprising:
transmitting a second network message from the PGW to a policy and charging rules function (PCRF), the second network message comprising the policy identifier, wherein the PCRF retrieves the policy profile from the policy repository using the policy identifier.

20. The system of claim 15, wherein the first network message comprises a packet data network (PDN) connectivity request.
